(19) United States
(12) Patent Application Publication
(10) Pub. No.: US 2007/0045021 A1
(43) Pub. Date: Mar. 1, 2007

(54) Steering for a maneuverable motorized personally operated vehicle

(76) Inventors: Mark E. Greig, Longmont, CO (US); Francisco Silva, Loveland, CO (US); Frank A. Borke, Windsor, CO (US)

Correspondence Address: MACMILLAN SOBANSKI & TODD, LLC, ONE MARITIME PLAZA FIFTH FLOOR, 720 WATER STREET, TOLEDO, OH, 43604-1619, US

(21) Appl. No.: 11/508,741

(22) Filed: Aug. 23, 2006

Related U.S. Application Data
(60) Provisional application No. 60/712,098, filed on Aug. 29, 2005.
(60) Provisional application No. 60/712,072, filed on Aug. 29, 2005.
(60) Provisional application No. 60/712,093, filed on Aug. 29, 2005.
(60) Provisional application No. 60/784,213, filed on Mar. 21, 2006.

(51) Int. Cl. B62D 61/06

(52) U.S. Cl. 180/211; 180/215

(57) ABSTRACT

A personal mobility vehicle includes a frame, a ground engaging front wheel connected to the frame and mounted for rotation about a substantially, vertical axis so the front wheel is a steerable wheel, and a drive motor connected to either the front wheel or the rear wheels, the drive motor being configured to drive the scooter. Two or more ground engaging rear wheels are connected to the frame and configured to support the frame. A tiller assembly is connected to the frame and configured to allow the vehicle user to steer the front wheel. A steering hub is connected to the frame and configured to rotatably support the tiller assembly, wherein the steering hub is forward of and spaced apart from the front wheel.

### RELATED APPLICATIONS

This application claims priority from U.S. Provisional patent application Ser. No. 60/712,098, filed Aug. 29, 2005, entitled SUSPENSION LINKAGE FOR MANEUVERABLE MOTORIZED PERSONALLY OPERATED VEHICLES, from U.S. Provisional patent application Ser. No. 60/712,072, filed Aug. 29, 2005, entitled MANEUVERABLE MOTORIZED PERSONALLY OPERATED VEHICLE, from U.S. Provisional patent application Ser. No. 60/712,093, filed Aug. 29, 2005, entitled STEERING LINKAGE FOR MANEUVERABLE MOTORIZED PERSONALLY OPERATED VEHICLES, and from U.S. Provisional patent application Ser. No. 60/784,213, filed Mar. 21, 2006, entitled MANEUVERABLE MOTORIZED PERSONALLY OPERATED VEHICLE, the disclosures of which are incorporated herein by reference.

### TECHNICAL FIELD

This invention relates to a personal mobility vehicle of the type useful for elderly and handicapped people, and more particularly to a personal mobility vehicle including scooters and wheelchairs, laving a high degree of maneuverability.

### BACKGROUND OF THE INVENTION

A motorized personal mobility vehicle is typically used by individuals requiring assistance with their mobility due to a physical limitation or disability. Examples of a personal mobility vehicle include scooters, manual wheelchairs and powered wheelchairs. A seat is also attached to the frame and supports the rider. Personal mobility vehicles typically have a drive wheel, or plurality of drive wheels, attached to a frame. The frame is also typically supported by a fixed wheel or a plurality of fixed wheels, such as caster wheels or anti-tip wheels. Electrical power is stored on the personal mobility vehicle using batteries, and the batteries are capable of providing sufficient power to properly energize the drives. Electronic controls are provided and actuated by the rider using an electronic control system that metes out sufficient power to the drive system from the batteries.

The steering of wheelchairs is usually accomplished by applying a different drive force to one of the drive wheels than to the other of the drive wheels. The steering of scooters is typically accomplished by pivoting of a single steered wheel. The pivoting of the steered wheel is usually activated through a user operated mechanical means, such as a tiller. Scooters can be configured as either front wheel drive vehicles or rear wheel drive vehicles. Rear wheel drive scooters typically use a single drive motor coupled to a differential transaxle that is connected to a pair of drive wheels, one on each side of the vehicle. In some cases, a differential transaxle connects each of the drive wheels to the motor drive, but allows for variation in speed between the two output wheels to compensate for turns. In a front wheel drive scooter the rear wheels are idler wheels that are free to rotate relative to the contact surface. The front wheel powers the scooter as well as provides the steering function. That is, the front wheel is connected both to a motor drive and to the steering mechanism. Typically the front wheel of scooters is positioned in front of the rider's feet. It would be advantageous if personal mobility vehicles could be improved to make them more maneuverable.

### SUMMARY OF THE INVENTION

A personal mobility vehicle includes a frame, a ground engaging front wheel connected to the frame and mounted for rotation about a substantially vertical axis so the front wheel is a steerable wheel, and a drive motor connected to either the front wheel or the rear wheels, the drive motor being configured to drive the scooter. Two or more ground engaging rear wheels are connected to the frame and configured to support the frame. A tiller assembly is connected to the frame and configured to allow the vehicle user to steer the front wheel. A steering hub is connected to the frame and configured to rotatably support the tiller assembly, wherein the steering hub is forward of and spaced apart from the front wheel.

According to this invention there is also provided a personal mobility vehicle having a frame, a ground engaging front wheel connected to the frame and mounted for rotation about a substantially vertical axis so that the front wheel is a steerable wheel, two or more ground engaging rear wheels connected to the frame and configured to support the frame, and a drive motor connected to either the front wheel or the rear wheels, the drive motor being configured to drive the personal mobility vehicle. A tiller assembly is connected to the frame and configured to allow the vehicle user to steer the front wheel, the tiller assembly further including a tiller handle, a tiller stem connected to the tiller handle, the tiller stem including a tiller stem base configured to rotate in an arc, a tiller extension connected to the tiller stem base and configured to distance the tiller stem base from the frame, and a steering hub connected to the frame and configured to rotatably support the tiller assembly.

According to this invention there is also provided a personal mobility vehicle having a frame, a ground engaging front wheel connected to the frame and configured to steer the personal mobility vehicle, a steering mechanism connected to the front wheel and configured to steer the front wheel, and two or more ground engaging rear wheels positioned rearward of the front wheel to support the personal mobility vehicle, the rear wheels being mounted to the fame by a rear wheel suspension that includes one or more rear wheel axles mounted for rotation about a pivot point, the rotation being in a substantially horizontal plane that is substantially parallel to the ground. A drive motor is connected to either the front wheel or the rear wheels, the drive motor being configured to drive the scooter.

According to this invention there is also provided a personal mobility vehicle having a frame, two or more ground engaging rear wheels connected to the frame and configured to support the frame, a ground engaging front wheel connected to the frame and mounted for rotation about a vertical axis so that the front wheel is a steerable wheel, and a drive motor connected to either the front wheel or the rear wheels, the drive motor being configured to drive the personal mobility vehicle. A steering mechanism is connected to the front wheel and configured to steer the front wheel. A centering mechanism is configured to urge the front wheel to a neutral position in response to turning of the steered front wheel away from the neutral position.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a side view in elevation of a personal mobility vehicle.

FIG. 2 is a perspective view of the personal mobility vehicle shown without the shroud.

FIG. 3 is a side view in elevation of the personal mobility vehicle shown without the shroud.

FIG. 4 is a plan view of the personal mobility vehicle.

FIG. 5 is a side view in elevation of the steering and drive wheel mounting mechanisms of the personal mobility vehicle.

FIG. 6 is a plan view of the steering and drive wheel mounting mechanisms of the personal mobility vehicle.

FIG. 6A is a plan view illustrating the centering mechanism in greater detail.

FIG. 7 is a perspective view of the steering and drive wheel mounting mechanisms, showing the centering assembly.

FIG. 8 is a top view of the personal mobility vehicle showing rotational angles of the tiller and the front drive wheel.

FIG. 9 is a plan view of a steering mechanism providing a variable steering ratio.

FIG. 10 a side view in elevation of an alternate version of the suspension for the front drive wheel of the scooter.

FIG. 11 is a side view in elevation of one embodiment of the rear wheel suspension of the personal mobility vehicle.

FIG. 12 is a front view in elevation of the rear wheel suspension of FIG. 11.

FIG. 13 is a side view in elevation of the rear wheel suspension, taken along line 13-13 of FIG. 12.

FIG. 14 is a side view in elevation of the rear wheel suspension when the personal mobility vehicle travels on an incline.

FIG. 15 is a side view in elevation of a different embodiment of the front wheel suspension, with the rear wheels and rear anti-tip wheels mounted on a pivot arm.

FIG. 16 is a side view in elevation of an alternative rear wheel suspension, where the rear anti-tip wheels are mounted for downward movement relative to the frame.

FIG. 17 is a side view in elevation of yet another rear wheel suspension where the rear support wheels are mounted for forward/rearward movement relative to the wheelchair frame.

FIG. 18 is a top view of an alternative embodiment of the front drive wheel.

FIG. 19 is a side view in elevation of a wheelchair configured with two front drive wheels.

FIG. 20 is a side view in elevation of a scooter having the seat mounted for pivoting to activate the rear anti-tip wheels.

FIG. 21 is a top view of a scooter frame having articulated rear wheels.

### DETAILED DESCRIPTION OF THE INVENTION

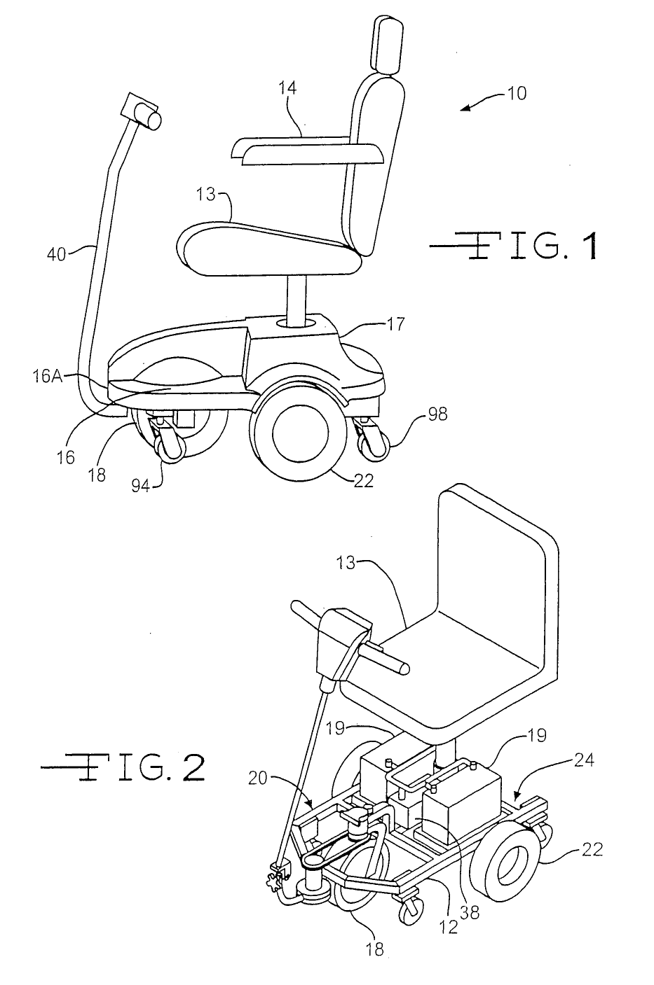

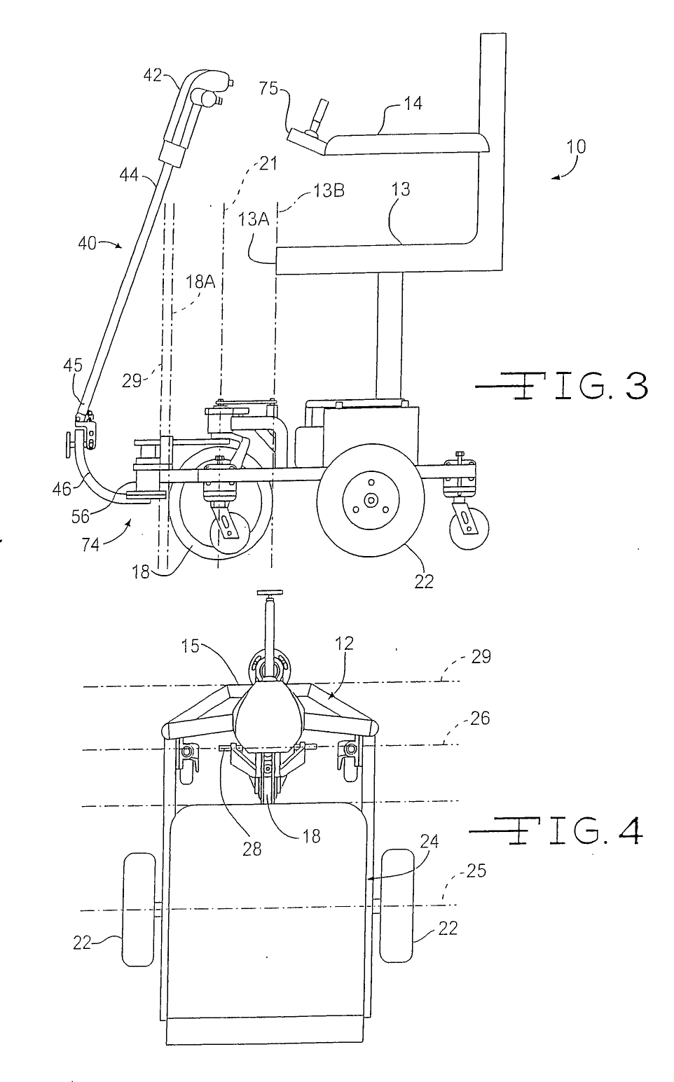

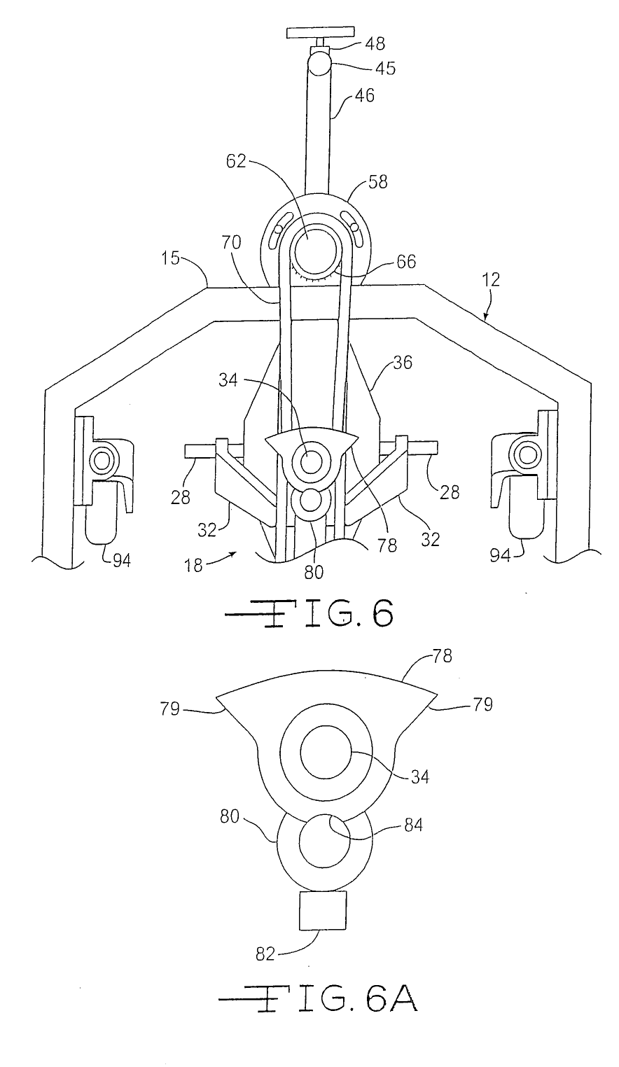

The description and drawings disclose a personal mobility vehicle for assisting individuals with their mobility due to a physical limitation or disability. The personal mobility vehicle can be a scooter as shown in FIG. 1 at 10, or can be a wheelchair or other similar vehicle designed to provide mobility to the elderly or handicapped. As shown in FIGS. 1-4, the scooter 10 includes a frame 12 that supports a seat 13 for the occupant of the scooter 10. As shown in FIG. 3, the seat 13 has a forward edge 13A. Optionally, the seat also has armrests 14. As can be seen in FIGS. 4 and 6, the frame 12 is generally rectangular with the forward end 15 of the frame 12 having angled corners. Other frame configurations can be used. The frame 12 is constructed of sections of tubular aluminum welded together, although the frame 12 can be constructed of any material, such as steel or structural plastic, suitable to provide a supporting framework for the scooter. Mounted on the frame 12 is a footrest 16 located forward of the seat 14 to position and support the feet of the occupant of the scooter 10. The footrest can optionally be integrally formed as part of the shroud 17. The frame 12 is supported by a ground engaging front drive wheel 18 mounted in a front wheel suspension 20, and by ground engaging rear support wheels 22 mounted in a rear wheel suspension 24. The front drive wheel 18 is supported by the front wheel suspension 20 and mounted for rotation about a vertical axis 21 so that the front drive wheel 18 is a steerable wheel. Batteries 19 can be mounted on the frame to provide power for the front drive wheel 18. The rear support wheels 22 are aligned along a horizontal axis 25 normal to the direction of fore/aft motion of the scooter 10, as shown in FIG. 4.

The front drive wheel 18 has a horizontal center line 26 extending through its horizontal axis, as shown in FIG. 4. When the front drive wheel 18 is oriented so that it is pointing straight forward, as shown in FIGS. 1-6, the horizontal center line 26 is collinear with the axle 28 of the front drive wheel 18. It can be seen that the front drive wheel 18 of the scooter 10 is positioned further rearward relative to the frame than the typical position of front wheels in conventional scooters or in conventional wheelchairs. By moving the front drive wheel 18 rearward relative to the frame 12, the front drive wheel 18 is positioned closer to the rear drive wheel than in conventional personal mobility vehicles. The position of the center line 26 of the front drive wheel 18 relative to the rear wheels 22 determines the turning radius of the scooter 10. In one particular embodiment, the centerline of the front wheel 18 is spaced apart from the horizontal axis 25 of the rear wheels 22 by a distance that is less than about 25 inches (64 cm). In another embodiment, the spacing is less than about 22 inches (56 cm). In another embodiment, the spacing is about 20 inches (50 cm). These embodiments can be operative whether the front wheel is a steered, driven wheel, or, alternatively if the front wheel is merely a steered wheel and the drive for the scooter is carried out by the rear support wheels 22. A short turning radius allows the scooter 10 to maneuver in tight spaces, and enables the scooter 10 to have an overall compact size. In one embodiment of the invention, the center line 26 of the front drive wheel 18 is positioned rearward of the forward end line 29 of the frame, and is also positioned forward of the rear wheels 22, as shown in FIG. 4.

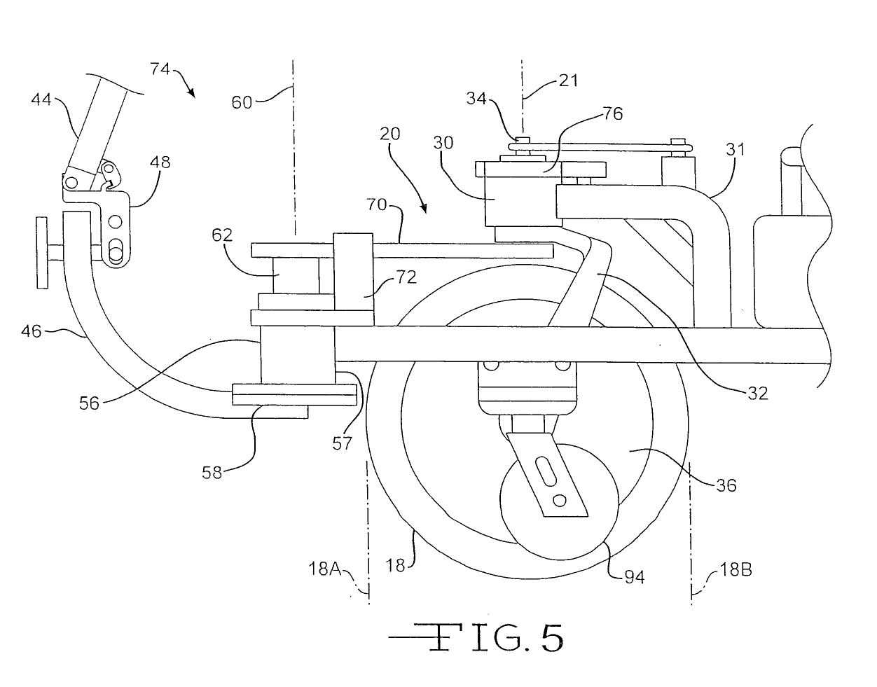

As shown in FIGS. 5 and 6, the suspension 20 for the front drive wheel 18 includes a wheel hub 30 which provides a mounting for the front drive wheel 18. The wheel hub 30 can be supported relative to the frame 12 by a hub bracket 31, or by any other suitable means. The horizontal axle 28 of the front drive wheel 18 is supported by wheel forks 32 extending downward from a front wheel rotation shaft 34 positioned within the hub 30 for rotation about the vertical axis 21. This mounting arrangement allows the front drive wheel 18 to rotate in any direction for driving and steering the scooter 10. The wheel hub 30 is configured such that the vertical axis 21 of the wheel hub 30 is aligned with a vertical line though the front drive wheel 18, although other configurations are possible. Although the suspension is shown as having two wheel forks 32, the front drive wheel 18 can be supported using a single wheel mounting arm or bracket, not shown.

As shown in FIGS. 5 and 6, the front drive wheel 18 includes an in-hub drive motor 36 for powering the front drive wheel 18. Alternatively, the front drive wheel can be powered by an exterior motor, not shown, attached to the front drive wheel 18 through a gear box, also not shown, or through any other means. Also, the front drive wheel 18 can be connected in any other configuration with a source of power sufficient for rotation of the drive wheel 18 and propulsion of the scooter 10. A controller 38, shown in FIG. 1, can be provided to control the functioning of the front drive wheel 18 as well as other systems of the scooter.

As shown in FIGS. 3 and 5 the scooter 10 is provided with a tiller assembly 40 to enable the user to steer the scooter 10 as desired. The tiller assembly is supported on the frame 12, and includes a tiller handle 42 which is typically grasped by the vehicle user for controlling the movement of the scooter 10. The tiller handle 42 may optionally include controls, not shown, for the operation of the scooter 10. The tiller handle 42 is mounted on a tiller stem 44, which extends upwardly from the scooter frame 12. The tiller stem 44 has a lower portion or tiller stem base 45. The tiller stem 44 positions the tiller handle 42 at a location that enables the vehicle user to comfortably reach and operate the tiller assembly 40 to control and steer the scooter. As shown, the tiller stem 44 consists of a long, straight member, which can be tubular. The tiller stem 44 can be made of any suitable material, such as aluminum, steel, or plastic, and can be of any length and shape suitable to position the tiller handle 42 in a comfortable and suitable position for the vehicle user. The tiller assembly 40 also includes a tiller extension 46 that mounts the tiller stem 44 to the frame 12 of the scooter. The use of the tiller extension 46 provides a structure in which the tiller stem base 45 is configured to rotate in an arc as the tiller assembly 40 is rotated to steer the scooter 10. The tiller extension enables the base of the tiller stem 44 to be positioned forward of the frame 12. This is advantageous for favorable positioning of the tiller handle since the short wheelbase of the scooter 10 shortens frame 12. In this embodiment, the tiller extension 38 is a curved member. However, the tiller extension 38 can be any shape, length or size sufficient to distance the tiller assembly 40 from the frame 12.

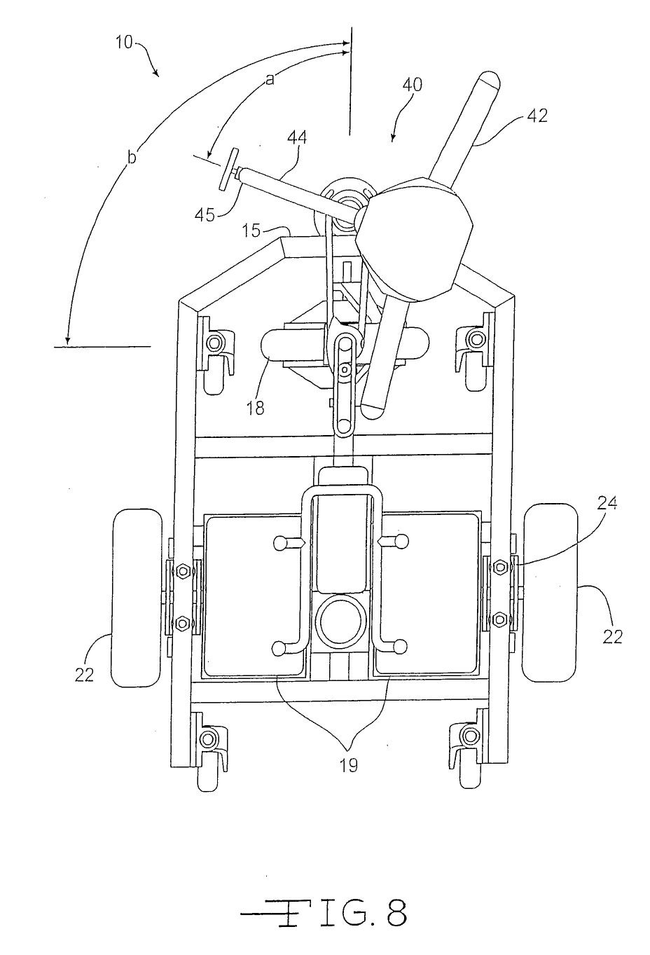

One of the features of the use of the tiller extension 46 is that it enables a shorter profile than that offered by conventional scooters. It can be seen in FIG. 6 that when the front wheel 18 is steered to be oriented in the forward direction, the tiller stem base 45 is positioned well in front of the front 15 of the scooter. In contrast, as shown in FIG. 8, when the steered wheel 18 is turned to its maximum extent, the tiller stem base 45 is much closer to the front 15 of the scooter. This feature gives the effect of shortening the effective length of the scooter during a sharp turn, thereby increasing the maneuverability of the scooter when it is needed most.

The connection 48 between the tiller stem 44 and the tiller extension 46 can be of any configuration. As shown, the connection 48 allows the tiller stem to be folded out of the way to facilitate access to the scooter by the user. The connection 48 optionally can also be configured with a quick release feature for ease of storage and transportation of the scooter. The connection 48 can also be configured to allow adjustment of the angle between the stem 44 and the tiller extension. The quick release mechanism can be any mechanism, including clips, springs, clamps, or fixtures, suitable to allow the tiller stem 44 to be easily and readily connected to and disconnected from the tiller assembly 40. It is to be understood that the tiller extension is an optional feature, and the tiller stem can be connected directly to the frame 12.

The connection of the tiller extension 46 to the frame 12 is through the steering hub 56, which is mounted on the forward end 15 of the frame. As can be seen in FIGS. 3 and 5, in this embodiment, the steering hub 56 is positioned forward of and spaced apart from the front wheel forward edge line 18A of the front drive wheel 18. The steering hub 56 is substantially a hollow cylinder, although other shapes can be used. The steering hub has a rearward edge 57, as shown in FIG. 5. A tiller assembly mounting plate 58, to which the tiller extension 46 is mounted, is located at the lower end of the steering hub 56, but is not fixed to the steering hub. The steering hub 56 has a substantially vertical axis 60. A steering shaft 62 is mounted for rotation within the hub to rotate about the hub vertical axis 60. The tiller assembly mounting plate 58 is connected to the steering shaft 62 so that when the steering shaft rotates, the tiller assembly mounting plate 58 also rotates. The hub 56 therefore acts as the pivot axis for the tiller extension 46 and the entire tiller assembly 40. It is to be understood that the tiller assembly mounting plate 58 can be connected to the steering hub 56 in any position or configuration that allows rotation of the tiller assembly 40 about the vertical axis 60 of the steering hub 56. It can be seen that as the scooter 10 is operated, rotation of the tiller handle 42 about the hub vertical axis 60 will rotate the steering shaft 62.

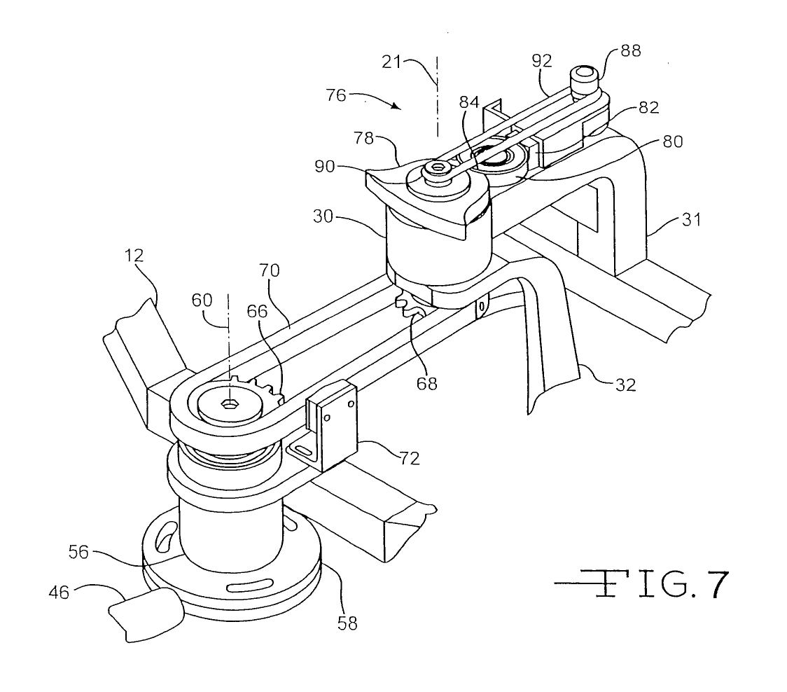

Positioned at the top end of the steering shaft 62 is a steering sprocket 66, shown in FIGS. 6 and 7. A similar sprocket, drive sprocket 68, is mounted on the front wheel rotation shaft 34 which positioned within the hub 30 for rotation about the vertical axis 21. A linkage member, such as chain 70, is threaded around both the steering sprocket 66 and the drive sprocket 68 so that rotation of the steering sprocket 66 causes rotation of the drive sprocket 68. The chain 70 can be optionally provided with a chain tensioner 72. In operation, as the tiller assembly 40 rotates about axis 60, which causes the steering shaft 62 to rotate within the steering hub 56 and about the steering hub axis 60, and the steering sprocket 66 turns in the same rotational direction. The turning of the steering sprocket 66 forces the chain 70 to cause a corresponding turn in the drive sprocket 68. Turning of the drive sprocket 68 causes a corresponding turn of the front wheel rotation shaft 34, which turns the forks 32 to steer the front drive wheel 18 in the desired direction. Although the linkage member 70 is shown in the form of a chain, it is to be understood that other types of linkage members, such as cables and belts, also can be used. For example, the steering mechanism 74 could consist of a pulley and belt assembly, a belt and cam assembly, a linked cam follower system, a rack and pinion assembly, an electronic system, or any equivalent means sufficient to angularly rotate the front drive wheel 18 in response to angular rotation of the tiller assembly 40.

It can be seen that the tiller assembly 40, the steering hub 56 with its associated apparatus, and the wheel hub 30 and its associated apparatus, form a steering mechanism 74 capable of controlling the direction of the front drive wheel 18 by the action of the tiller handle 42. In general, all of this apparatus can be referred to as a steering mechanism 74, indicated in FIGS. 3 and 5. It is to be understood that the steering mechanism 74 need not contain all of the specific elements disclosed, and other designs for the steering mechanism can be used to steer the front wheel. It is to be understood that alternate steering systems other than the steering mechanism 74 can be used to steer the front drive wheel 18 of the scooter. Such an alternate steering mechanism could consist of an optional user actuated joy stick 75 and electronically controlled actuators, not shown, or any other means sufficient to turn the front drive wheel 18 to the direction desired by the occupant of the scooter 10.

The scooter 10 has been described as having a drive motor connected to the front drive wheel 18 to propel the scooter. The rear support wheels 22 have been described as mere support wheels, with no connection to any drive mechanism. It is to be understood that the scooter can be configured with the front wheel as a passive wheel for steering only, and not for propulsion, and with the rear support wheels 22 being connected to a drive mechanism for moving the scooter.

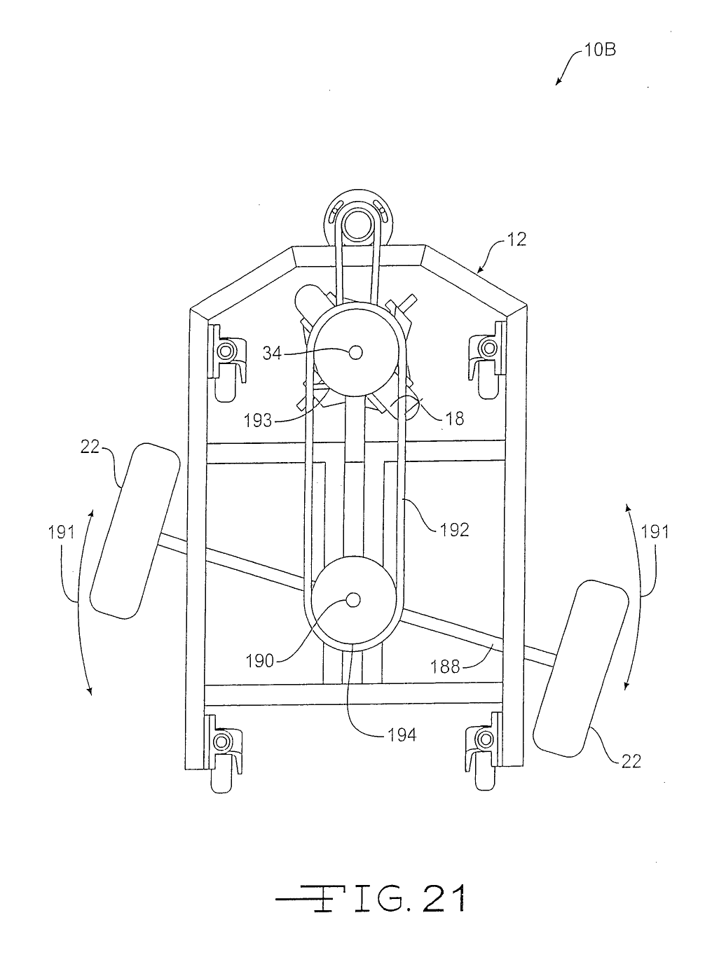

As shown in FIG. 21, in an optional embodiment, a scooter 10B includes a front steered wheel 18 and two rear support wheels 22. The axle 188 for the rear support wheels 22 is mounted on a pivot point 190 so that the axle can be rotated with respect to the frame 12, in the direction of arrows 191. The axle 188 can be described as an articulated axle since it rotates about pivot point 190, with the rotation being in a horizontal plane that is substantially parallel to the ground. The axle 188 can be a single axle, or can be separate, substantially co-linear half axles. By rotating the axle 188, the turning radius of the scooter 10B can be reduced. The axle can be rotated by any suitable means, such as by a belt 192 mounted about front pulley 193 and rear pulley 194, respectively. The front pulley 193 can be mounted on the front wheel rotation shaft 34 so that the axle 188 will rotate in unison with the front wheel 18. Other means can be used to articulate or steer the rear wheels 22. Also, the articulated rear wheels of this embodiment can be used with the front drive wheel being a steered wheel or a on-steered wheel. Further, the articulated rear wheels of this embodiment can driven or merely passive.

As shown in FIGS. 5-7, an optional centering assembly 76 is connected to the frame 12 and configured to maintain the front wheel in a neutral position. The centering assembly 76 includes a centering cam 78 that is mounted on the front wheel rotation shaft 34. A centering disc 80, mounted for forward/rearward movement, is urged by a spring mechanism 82 into contact with the centering cam 78. The rearward surface 84 of the centering cam 78 is configured with a concave edge, as shown in FIG. 6A. When the tiller assembly 40 is rotated to turn the front wheel 18, the front wheel rotation shaft 34 rotates. This action causes the centering cam 78 to rotate, thereby changing the portion of the centering cam that is in contact with the centering disc 80. Since the concave portion of the centering cam surface 84 is no longer directly aligned with the concave surface of the centering disc, the disc 80 is pushed rearwardly, against the force of the spring mechanism 82. This creates potential energy, and results in an urging of the centering cam 78, and hence the front drive wheel 18, into a straight on or straight forward alignment. Increasing pressure is applied against the centering cam 78 as the angle of the turn of the front wheel rotation shaft 34 increases. Other mechanisms can be used to return the front drive wheel 18 to a neutral position. Examples of such mechanisms include a spring system, an electronic system, a pneumatic system, a hydraulic system, and a rack and pinion system, all not shown. The centering cam 78 optionally has two wings or oblique surfaces 79 that act as stops to limit the amount of turning of the font wheel 18.

The scooter 10 can optionally be provided with a control system that reduces the speed of the scooter whenever the front drive wheel 18 is turned away from the neutral position. This can be accomplished by connecting a potentiometer 88, shown in FIG. 7, with the front wheel rotation shaft 34. The connection can be made using a pulley 90 and belt 92, or in any other suitable manner. The potentiometer can be connected to controller 38.

It can be seen that the steering mechanism 74, including the tiller assembly 40, is connected to the front drive wheel 18 and allows the front drive wheel 118 to simultaneously drive and steer the scooter 10. In one embodiment, the front wheel center line or vertical axis 21 of the front drive wheel 18 is positioned rearward of the footrest 16 and forward of the rear wheels 24. The position of the center line 121 of the front wheel 18 is important to enable the scooter 10 to maneuver in tight spaces by providing a short turning radius, and to allow an overall compact size for the scooter 10. In another embodiment, as shown in FIGS. 1 and 3, the front wheel center line or vertical axis 21 of the front drive wheel 18 is positioned rearward of the front edge 16A footrest 16, and forward of the rear wheels 24.

As shown in FIG. 3, the seat 13 has a forward edge 13A, defining a seat forward edge line 13B. In yet another embodiment, the center line 21 of the front wheel 18 is positioned such that it is rearward of a line positioned no further than about 8 inches (20 cm) forward of the seat forward edge line 13B of the seat 13. In other words, the center line 21 of the front wheel 18 is positioned forward of the rear wheels 24 and rearward of a line that is about 8 inches (20 cm) forward of the seat forward edge line 13B of the seat 13. In another embodiment, the front wheel 18 is positioned forward of the rear wheels 24 and rearward of a line that is about 3 inches (7.6 cm) forward of the seat forward edge line 13B of the seat 13.

As shown in FIG. 3, in another embodiment, the center line 21 of the front wheel 18 is positioned rearward of the axis 60 of the steering hub 56. This enables the scooter 10 to maneuver in tight spaces by providing a short turning radius, and allows an overall compact size for the scooter 10.

As can be seen in FIGS. 3 and 4, the front drive wheel 18 has a forward edge, through which front wheel forward edge line 18A extends. It can be seen that according to another embodiment the front wheel forward edge line 18A of the front wheel is positioned forward of the rear wheels 24 and rearward of the forward edge line 29 of the frame front end 15.

As can be observed in FIG. 8, as the tiller assembly 40 is turned from a neutral position to the left to steer the scooter 10 in the left hand direction, the tiller assembly will travel through an arc indicated at “a”. The front drive wheel 18 rotates, in response to the turning of the tiller assembly 40, through an arc “b”. In one embodiment, the arc “a” is 70 degrees, and the arc “b” is 90 degrees. Similar arcs apply for turning to the right.

In the embodiment of the scooter 10 illustrated in the drawings, the steering mechanism 74 is configured to provide a fixed steering ratio. That is, the ratio of the angle of the tiller assembly 40 from an initial position to the angle of the front drive wheel 18 from its initial position remains fixed and is constant through the entire turn as the user of the scooter 10 rotates the tiller assembly 40. The steering ratio (i.e., the ratio of front drive wheel arc “b” to tiller assembly arc “a”) can be fixed at any ratio including a ratio of 1:1, or a ratio that is greater than or less than 1:1. In a specific embodiment, the steering ratio is at least 1.1:1. In another embodiment, the is ratio is 1.14:1. While the steering mechanism 74 providing the fixed steering ratio, as shown in FIGS. 5-7 consists of a chain driven system, the steering mechanism 74 can be configured with numerous mechanisms, including a pulley and belt assembly, a belt and cam assembly, a linked cam follower system, a rack and pinion assembly, an electronic system or any other equivalent means sufficient to angularly rotate the front drive wheel 18 from angular rotation of the tiller assembly 30.

In another embodiment of the scooter 10, as shown in FIG. 9, the steering mechanism assembly 174 is configured to provide a variable steering ratio. That is, the ratio of the angle of the tiller assembly 40 from a neutral position to the angle of the front wheel 18 from its neutral position varies as the occupant of the scooter turns the tiller assembly. Varying the steering ratio is desirable in that a motion-impaired user of the scooter can obtain full angular motion of the ground engaging front wheel 18 with less than full angular rotation of the tiller assembly 40, resulting in higher steering sensitivity at sharper turns. In this embodiment, the steering ratio is varied by using a steering mechanism assembly 174 consisting of an elliptical steering gear 166 supported by the steering shaft 62 directly connected to an elliptical drive gear 168 supported by the front wheel rotation shaft 34. In operation, angular rotation of the elliptical steering gear 166 causes angular rotation of the elliptical drive gear 168 of a different rotational magnitude as the angular rotation increases or decreases. In this embodiment, the variable ratio steering is accomplished through the use of elliptical gears 166 and 168. It is to be understood that the variable steering ratio may be carried out using numerous other means, including a steering mechanism assembly that consists of elliptical pulleys and a belt, a belt and cam assembly, a linked follower system, a rack and pinion system, or an electronic system, or any other means sufficient to vary the steering ratio.

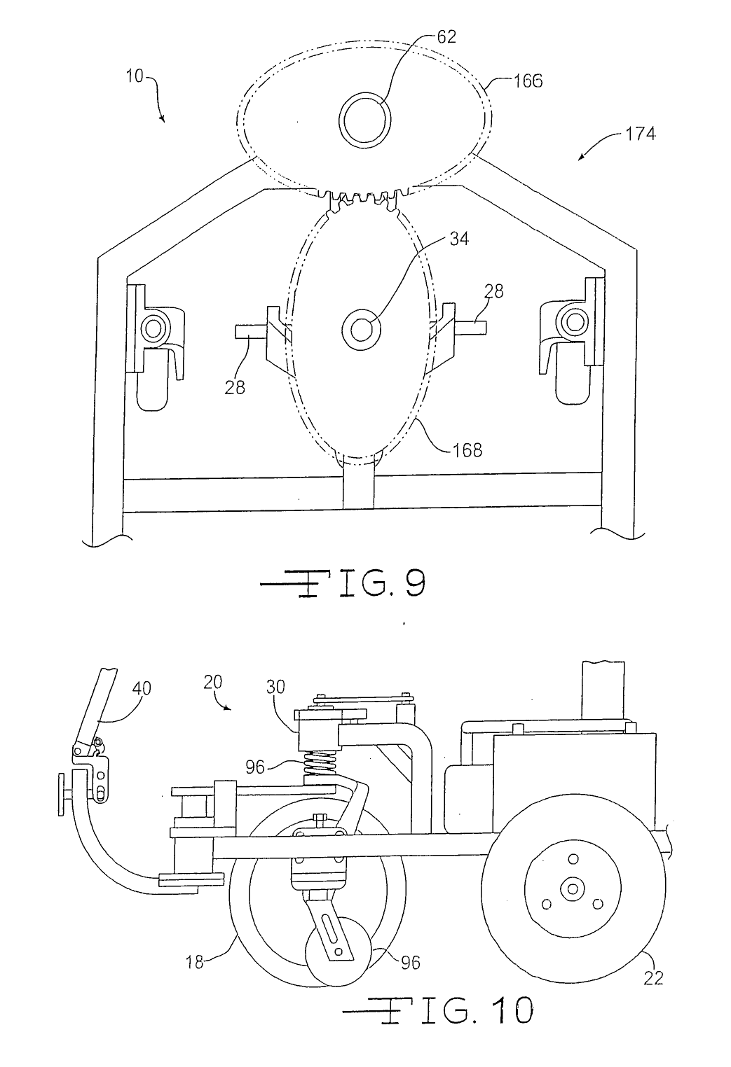

As shown in drawings, the scooter 10 includes two or more front anti-tip wheels 94 connected to the frame 12. The front anti-tip wheels 94 can be caster wheels, idler wheels, or any other wheels, or skids, suitable to help prevent the scooter from tipping sideways. The front anti-tip wheels 94 are normally off the ground, and are normally fixed with respect to the frame, although other configurations are possible. In one embodiment, the front anti-tip wheels 94 are positioned laterally outward from the front drive wheel 18, as shown in the drawings. In another embodiment, the front anti-tip wheels 94 are positioned forward of the rearward edge line 18B of the front wheel 18, as shown in FIG. 5. The front anti-tip wheels 94 can also be positioned rearward of the front drive wheel forward edge line 18A. The front wheel suspension 20 can be provided with a front wheel biasing mechanism configured to urge the front wheel into contact with the ground. This biasing mechanism can be a suspension actuator, such as a spring 96 that is configured to urge the front drive wheel 18 downward with respect to the frame, as shown in FIG. 10. This helps the front drive wheel 18 maintain constant contact with the ground in uneven terrain. Therefore, if the scooter were to be driven over a depression and the scooter were to tend to be supported by the laterally outboard anti-tip wheels 94, the spring 96 will tend to force the front drive wheel 18 downward into the depression to maintain contract with the ground. Although the front suspension actuator is shown as a spring 96, it can be embodied in numerous other configurations, such as a resilient member, a motorized system, a hydraulic system, a pneumatic system, a rotating screw system, a drive chain system, a jackscrew system, and an induction coil system.

As shown in drawings, the scooter 10 includes two or more rear anti-tip wheels 98 connected to the frame 12 and positioned at the rear of the scooter 10. It should be understood that the term “anti-tip wheels” includes anti-tip wheels, casters and idler wheels. During normal operation of the scooter 10, the rear anti-tip wheels 98 may be configured to be normally off the ground. In other embodiments, the anti-tip wheels are configured to be normally on the ground. In the event the anti-tip wheels 98 are touching the ground in normal operation, the anti-tip wheels 98 may be configured to provide little or no support to the frame 12 or to the weight distribution of the scooter 10, or may be configured to support substantial weight.

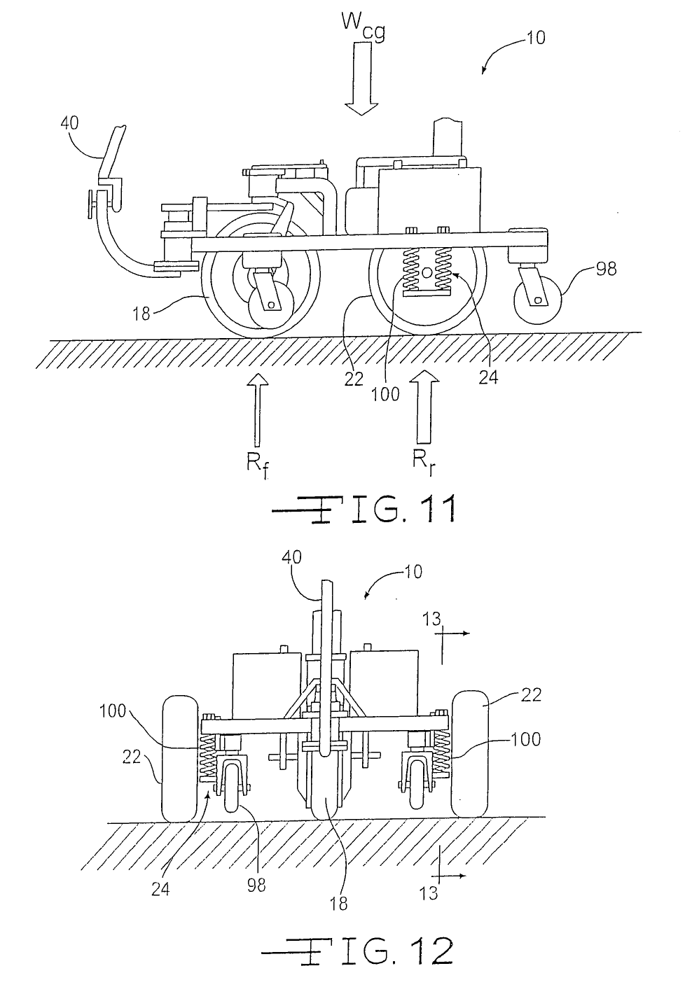

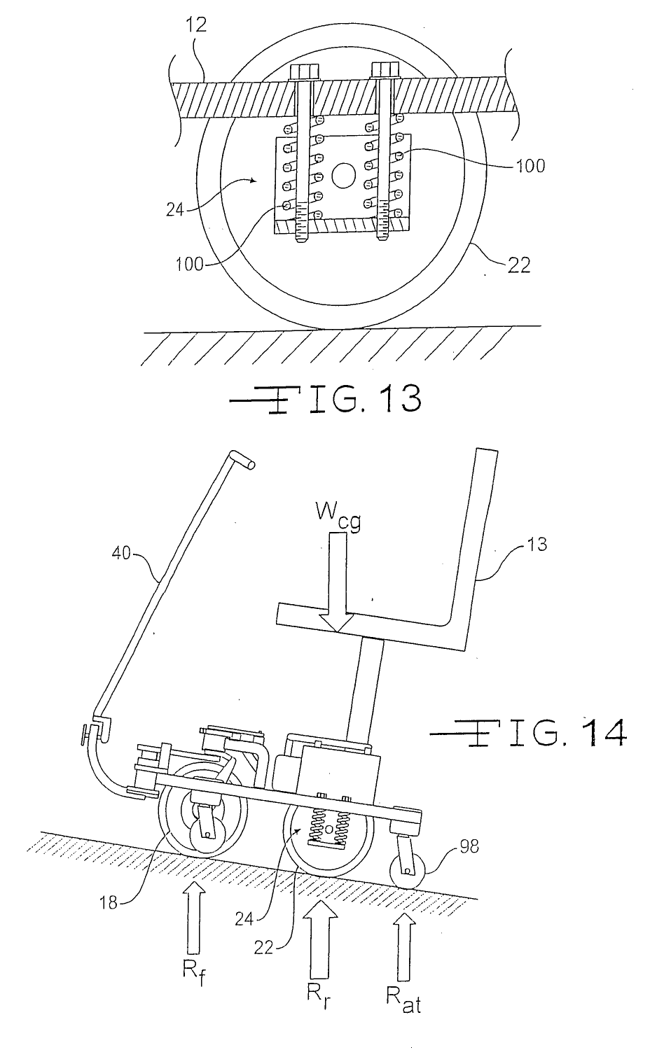

As shown in FIGS. 11-14, the frame 12 is supported by a rear wheel suspension 24 that includes two or more ground engaging rear support wheels 22 positioned forward of the rear anti-tip wheels 98. The rear wheels 22 are mounted for rotation and aligned along horizontal axis 25, shown in FIG. 4, normal to the direction of fore/aft motion. In one particular embodiment of the invention, the rear wheel suspension 24 is configured to mount the rear wheels 22 for vertical movement with respect to the frame 12.

Optionally the rear wheel suspension 24 also includes a rear wheel biasing mechanism arranged to urge the rear wheels vertically downward with respect to the frame. This biasing mechanism can be in the form of springs 100, as shown in FIGS. 11-14. The spring force of the springs 100 can be set to balance the weight of the scooter and the expected weight of the scooter user so that the rear wheels maintain contact with the ground when the scooter is on level terrain. In this embodiment, the rear anti-tip wheels 98 are usually off the ground, and the springs 100 support all of the weight of the rear portion of the scooter 10. As shown in FIG. 11, the force vector W_{cg} indicates the weight of the scooter and user, the force vector R_{f} indicates the reaction force of the weight applied to the front drive wheel 18, and the force vector Rᵣ indicates the reaction force of the weight applied to the rear wheels 22. In a specific embodiment of the scooter, approximately 25 percent of the weight of the scooter and occupant is applied to the front drive wheel 18, and 75 percent of the weight is applied to the rear wheels 22 when the scooter is on level ground.

When the scooter is operated on an incline, facing uphill as shown in FIG. 14, the weight distribution tends to shift, applying more of the weight onto the rear wheels 22 and less of the weight onto the front drive wheel 18. This has the unwanted result of reducing the traction of the front drive wheel 18 against the ground, making it difficult to ascend the inclined surface. The biasing mechanism, in the form of the springs 100, is able to counteract or reduce this tendency to unload weight from the front wheel 18. The natural shift of weight to the rear wheels 22 creates more pressure on the springs 100, and the resultant compression of the springs lowers the frame 12 toward the ground. Eventually, as the frame is lowered, the rear anti-tip wheels 98 come into contact with the ground. Once the rear anti-tip wheels 98 are in contact with the ground, they will bear some of the weight of the scooter and occupant. This distributes some of the weight of the scooter away from the rear wheels 22 and onto the anti-tip wheels 98, and retards the unloading of weight from the front wheel 18, thereby helping to maintain the traction of the front wheel. The traction maintaining system of disclosed above has been found to be sufficient to enable the scooter to travel uphill on an incline of at least 4 degrees, and in some cases at least 8 degrees.

As shown in FIG. 14, the force vector W_{cg} indicates the weight of the scooter and user, the force vector R_{f} indicates the reaction force of the weight applied to the front drive wheel 18, the force vector Rₐₜ indicates the reaction force of the weight applied to the rear wheels 22, and the force vector Rₐₜ indicates the reaction force of the weight applied to the rear anti-tip wheels 98. The upward movement of the rear wheels 22 with respect to the frame 12, and the resultant contact of the anti-tip wheels 98 with the ground, results in a re-distribution of the weight from the rear wheels 22 onto the rear anti-tip wheels 98, and also retards the unloading of the weight from the front wheel 18 that results when the scooter is on an incline.

Although the rear wheel biasing mechanism is shown as a pair of springs 100, it should be understood that the biasing mechanism can be any means of moving the rear wheels 22 relative to the frame 12 as the scooter 10 traverses an incline, including a motorized system, a hydraulic system, a pneumatic system, a rotating screw system, a drive chain system, a jackscrew system, an induction coil system or any other means. The scooter 10 an be provided with a sensor, such as an inclinometer, not shown, to sense the angle of incline. The sensor can be connected to the controller 38 for modifying the biasing mechanism as necessary, in response to the sensed angle of incline, to shift weight to the front drive wheel 18 for the desired traction.

The scooter can be configured so that it can be calibrated to accommodate the weight of any particular user. First the user is positioned in the scooter. This action compresses the spring 100 and lowers the frame 12 with respect to the ground. The rear anti-tip wheels 98 are provided with an adjustment mechanism, such as a screw mechanism, which allows the rear anti-tip wheels to be moved up or down relative to the frame. Other mechanisms can be used. In this manner the scooter is calibrated to accommodate the weight of an individual user. In one embodiment, the anti-tip wheels are adjusted so that they are approximately 0.95 cm (about ⅜ inches) above the ground. In another embodiment, the anti-tip wheels are adjusted so that they are spaced above the ground a distance within the range of from about 0.5 cm to about 1.5 cm.

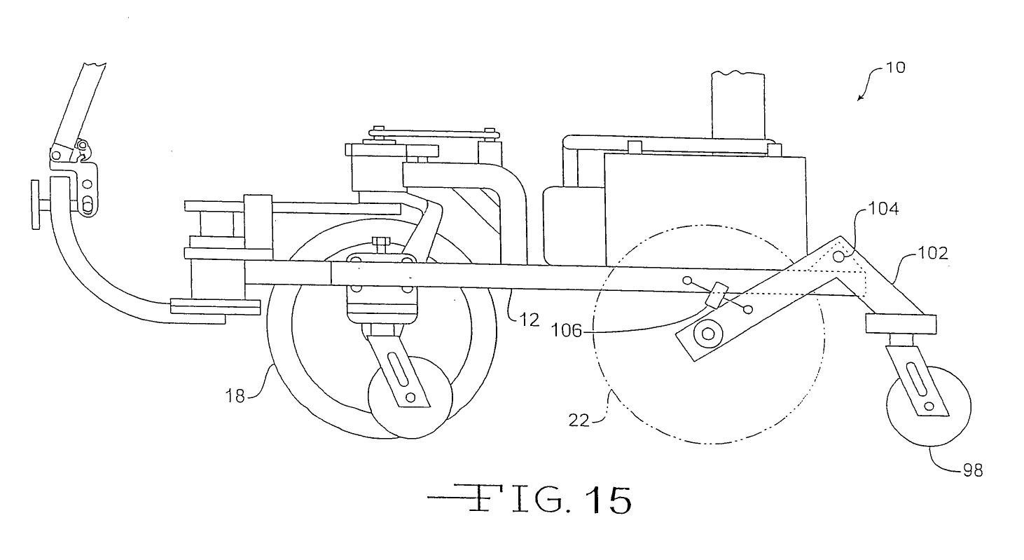

As shown in FIG. 15, in another embodiment, the scooter 10 can be optionally provided with a pivot arm 102. The drive wheels 22 are mounted on the forward end of the pivot arm 102, and the rear anti-tip wheels 98 are mounted on the rearward end. The pivot arm 102 is mounted for pivoting with respect to the frame at pivot point 104. The pivot arm can be of any shape or configuration suitable for mounting the rear wheels 22 and rear anti-tip wheels 98 to the frame. An actuator 106 is connected to the pivot arm 102 to move the pivot arm relative to the frame and thereby change the position of the rear wheels 22 and the rear anti-tip wheels 98 relative to the frame. The actuator can be any means for rotating or pivoting the pivot arm relative to the frame. A sensor, not shown, which can be connected to the controller 38, can be provided to sense the angle of the incline experienced by the scooter 10. The controller 38 is configured to control the rear suspension actuator 106 in response to a signal from the sensor. In operation, the controller 38 can be configured to automatically initiate movement of the pivot arm actuator 106 to rotate the pivot arm 102, thereby simultaneously forcing the rear wheels 22 upward relative to the frame and forcing the anti-tip wheels 98 downward relative to the frame as the scooter 10 traverses an incline. The movement of the rear wheels 22 and the anti-tip wheels 98 causes some of the weight loading of the scooter 10 to be distributed to the anti-tip wheels 98, thereby retarding the natural unloading of the weight from the front wheel that occurs when the scooter is on an incline. The pivot arm actuator can be any means of moving the rear wheels 22 and the anti-tips wheels 98 relative to the frame 12 as the scooter 10 traverses an incline, including a motorized system, a hydraulic system, a pneumatic system, a rotating screw system, a drive chain system, a jackscrew system, and an induction coil system.

As shown in FIG. 16, in another embodiment of the personal mobility vehicle, the rear anti-tip wheels 98 are provided with an anti-tip wheel activation system 108. The anti-tip actuation system 108 is structured to force the anti-tip wheels 98 downward relative to the frame 12. Additionally, a sensor, not shown, can be provided to sense the angle of incline as the scooter 10 traverses an incline. The sensor can be connected to the controller 38, and the controller can be configured to control the anti-tip actuation system 108 in response to a signal from the sensor. In operation, the controller 38 can be configured to automatically initiate movement by the anti-tip actuation system 108, thereby forcing the anti-tip wheels 98 downward relative to the frame as the scooter traverses an incline. As the rear anti-tip wheels are moved downward relative to the frame, the weight loading of the scooter is redistributed to remove some weight from the rear wheels 22 and onto the anti-tip wheels 98, thereby retarding the natural unloading of the weight from the front wheel that occurs when the scooter is on an incline. The anti-tip actuation system 108 can be a pneumatic system, or any other means for moving the rear anti-tip wheels downward relative to the frame, including such means as a motorized system, a hydraulic system, a rotating screw system, a drive chain system, a jackscrew system, and an induction coil system.

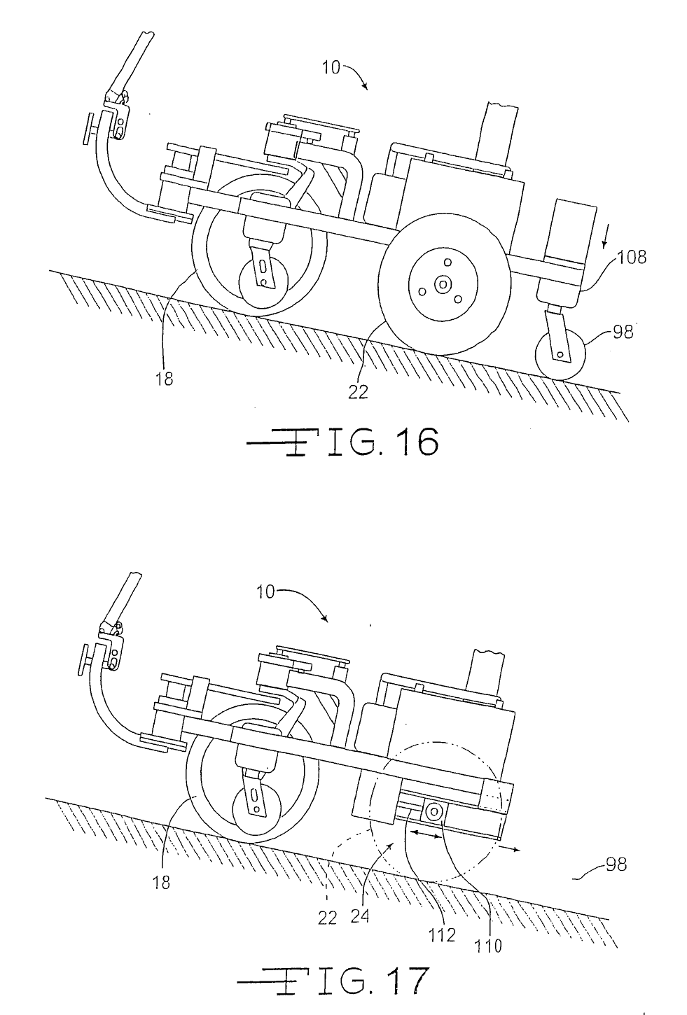

As shown in FIG. 17, in another embodiment of the personal mobility vehicle, the rear suspension 24 of the scooter 10 includes a mounting system to enable to the rear wheels 22 to move forward and rearward with respect to the frame 12. The rear wheels 22 are suspended from a carriage 110 which is mounted for traveling in the forward and rearward directions along a track or guide. An actuator 112 is connected to the carriage 110 to move the carriage along the guide in the forward/rearward directions. The actuator 112 can be configured in any suitable manner to move the rear wheels rearwardly with respect to the frame. A sensor, such as an inclinometer, can be connected to the controller 38 to automatically move the rear wheels rearwardly when the scooter 10 is on an incline facing uphill. In operation, the controller 38 can be configured to initiate movement by the rear suspension actuator 112, thereby forcing the rear wheels 22 rearward relative to the frame as the scooter 10 traverses an incline. Movement of the rear wheels 22 causes a redistribution of the weight loading of the scooter, thereby retarding the natural unloading of the weight from the front wheel that occurs when the scooter is on an incline. The actuator 112 could be any means of moving the rear wheels 22 rearward relative to the frame as the scooter 10 traverses an incline, including a pneumatic system, a motorized system, a hydraulic system, a rotating screw system, a drive chain system, a jackscrew system, and an induction coil system.

In all the embodiments described above, where an actuator is activated to shift weight from the rear wheels 22, the use of a sensor, such as an inclinometer, to activate the actuator can be replaced by a manual system operated by the user of the scooter.

While the front drive wheel 18 is disclosed as a single wheel, it is to be understood that the front drive wheel 18 can also include closely spaced dual wheels or any other wheel arrangement that allows the front drive wheel 18 to engage the ground and readily steer the scooter 10. As shown in FIG. 18, the front drive wheel 118 includes a pair of closely spaced individual wheels 120. This configuration is similar in nature to the pair of dual wheels used as the steered wheel commonly used on the forward ends of commercial aircraft. For purposes of this specification, the terms “front drive wheel” and “front steered wheel” includes such closely spaced dual wheels.

In one particular embodiment, as shown in FIG. 20, the seat 13 for scooter 10A is mounted for pivoting in a rearward direction relative to the frame when the personal mobility vehicle 10 is positioned on an incline facing uphill. This can be accomplished in any suitable manner, such as by mounting the seat 13 on a pivot arm, indicated at 180. The seat will pivot in the direction of the arrow 181. The pivot arm is biased forward with a spring 182. The seat is operatively connected to the anti-tip wheels 98 by means of a linkage 184 so that when the seat pivots rearward the anti-tip wheels 98 are forced down, thereby distributing some of the weight of the personal mobility vehicle 10 away from the rear wheels 22 and onto the anti-tip wheels 98. This shifting of weight retards the unloading of weight on the front wheel 18 that naturally occurs when the personal mobility vehicle is on an incline.

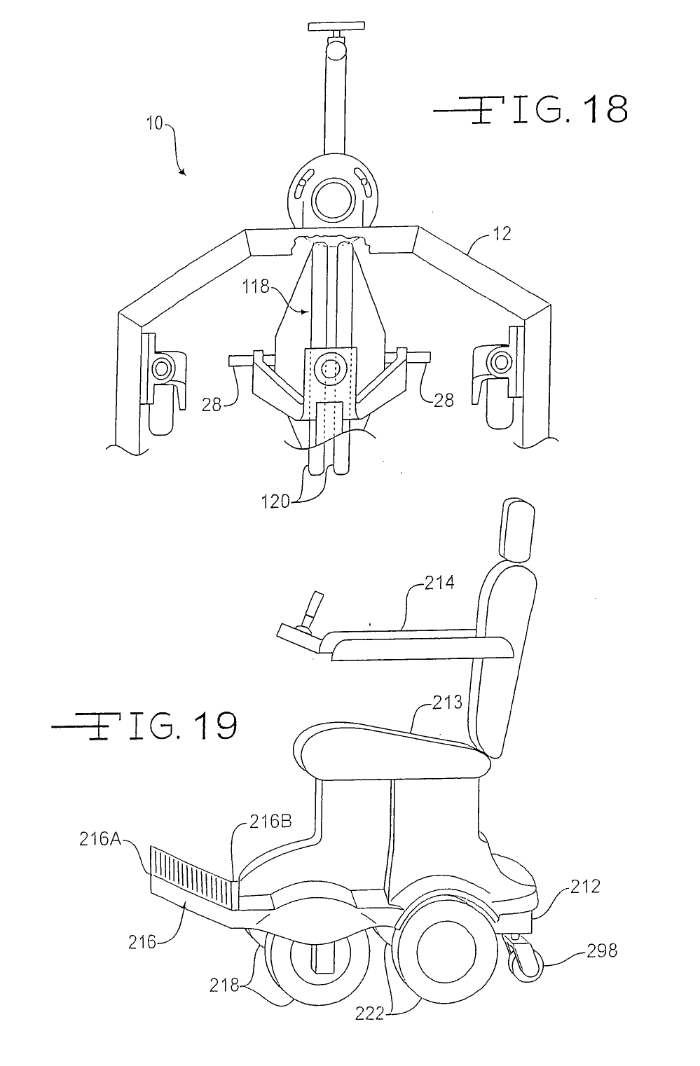

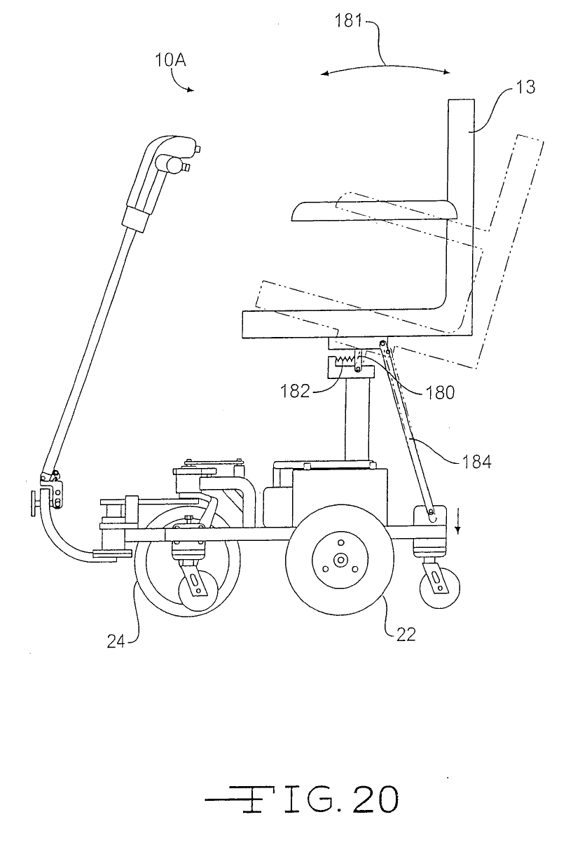

As shown in FIG. 19, the short wheelbase concept allowing improved maneuverability for a personal mobility vehicle can be applied to a wheelchair. The wheelchair, indicated at 210 includes a frame 212 that supports a seat 213 for the occupant of the wheelchair 210. Optionally, the seat also has armrests 214. Mounted on the frame 212 is a legrest 216 located forward of the seat 214 to position and support the feet of the wheelchair occupant. The legrest 216 has a forward edge 216A and a rear edge 216B, and can optionally be integrally formed as part of the shroud 217. The frame 212 is supported by a pair of ground engaging front drive wheels 218 that are similar to the ground engaging front drive wheel 218 described above with respect to the scooter 10. Ground engaging rear support wheels 222 are mounted from the frame 212, and rear anti-tip wheels 298 can also be provided. The front drive wheels 218 are mounted for rotation about vertical axes so that they are steerable wheels. The front wheels 218 each have a common center line when the front wheels are oriented in a forward/rearward direction, wherein the center line of the front wheels 218 is positioned rearward of the rear edge 216B of the legrest 216 and forward of the rear wheels. One or more drive motors are connected to the front wheels 218 and are configured to drive the front wheels 218. A steering mechanism is connected to the front wheels 218 and configured to steer them.

It will be understood by those skilled in the art that system of shifting the weight of the scooter 10 and the occupant onto the front drive wheel 18, or merely just removing some of the weight from the rear wheels so that the unloading of the weight from the front wheels can be retarded, can be described as a method of maintaining the traction of a scooter when the vehicle is on an inclined surface facing uphill. The scooter includes a front wheel configured to drive and steer the vehicle and rear wheels configured to support the vehicle. The front wheel is connected to a motor for propulsion. The method includes the steps of sensing that the personal mobility vehicle is on the inclined surface, and shifting some weight away from the rear wheels 22 to the anti-tip wheels 98 in response to sensing that the personal mobility vehicle is on an incline. The method of shifting the weight can include moving the rear anti-tip wheels downward, moving the rear wheels rearward, moving the front wheel forward, moving the batteries forward, moving the seat forward, or any combination of these steps. Other means of shifting weight also can be used.

In another embodiment, where the personal mobility vehicle includes a front wheel configured to drive and steer the vehicle and rear wheels configured to support the vehicle, with the front wheel being connected to a motor to drive the front wheel, the method comprises the steps of sensing the torque generated by the motor, and removing some of the weight from the rear wheels in response to increased torque on the motor.

The principle and mode of operation of this invention have been described in its preferred embodiments. However, it should be noted that this invention may be practiced otherwise than as specifically illustrated and described without departing from its scope.

What is claimed is:

1. A personal mobility vehicle comprising:
a frame;
a ground engaging front wheel connected to the frame and mounted for rotation about a substantially vertical axis so the front wheel is a steerable wheel;
a drive motor connected to either the front wheel or the rear wheels, the drive motor being configured to drive the scooter; and
two or more ground engaging rear wheels connected to the frame and configured to support the frame;
a tiller assembly connected to the frame and configured to allow the vehicle user to steer the front wheel; and
a steering hub connected to the frame and configured to rotatably support the tiller assembly, wherein the steering hub is forward of and spaced apart from the front wheel.

2. The personal mobility vehicle of claim 1 in which the tiller assembly further includes:
a tiller handle;
a tiller stem connected to the tiller handle, the tiller stem including a tiller stem base configured to rotate in an arc;
a tiller extension connected to the tiller stem base and configured to distance the tiller stem base from the frame; and
a steering hub connected to the frame and configured to rotatably support the tiller assembly, wherein the steering hub is forward of and spaced apart from the front wheel.

3. A personal mobility vehicle comprising:
a frame;
a ground engaging front wheel connected to the frame and mounted for rotation about a substantially vertical axis so that the front wheel is a steerable wheel;
two or more ground engaging rear wheels connected to the frame and configured to support the frame;
a drive motor connected to either the front wheel or the rear wheels, the drive motor being configured to drive the personal mobility vehicle;
a tiller assembly connected to the frame and configured to allow the vehicle user to steer the front wheel, the tiller assembly further including:
a tiller handle;
a tiller stem connected to the tiller handle, the tiller stem including a tiller stem base configured to rotate in an arc;
a tiller extension connected to the tiller stem base and configured to distance the tiller stem base from the frame; and
a steering hub connected to the frame and configured to rotatably support the tiller assembly.

4. A personal mobility vehicle comprising:
a frame;
a ground engaging front wheel connected to the frame and configured to steer the personal mobility vehicle;
a steering mechanism connected to the front wheel and configured to steer the front wheel;
two or more ground engaging rear wheels positioned rearward of the front wheel to support the personal mobility vehicle, the rear wheels being mounted to the fame by a rear wheel suspension that includes one or more rear wheel axles mounted for rotation about a pivot point, the rotation being in a substantially horizontal plane that is substantially parallel to the ground; and
a drive motor connected to either the front wheel or the rear wheels, the drive motor being configured to drive the scooter.

5. A personal mobility vehicle comprising:
a frame;
two or more ground engaging rear wheels connected to the frame and configured to support the frame;
a ground engaging front wheel connected to the frame and mounted for rotation about a vertical axis so that the front wheel is a steerable wheel;
a drive motor connected to either the front wheel or the rear wheels, the drive motor being configured to drive the personal mobility vehicle;
a steering mechanism connected to the front wheel and configured to steer the front wheel; and
a centering mechanism configured to urge the front wheel to a neutral position in response to turning of the steered front wheel away from the neutral position.
